(19) United States
(12) Patent Application Publication
(10) Pub. No.: US 2004/0090998 A1
(43) Pub. Date: May 13, 2004

(54) Portable DVD player system for video/audio and computer systems

(76) Inventor: Hong-xi Chen, Los Angeles, CA (US)

Correspondence Address: Raymond Y. Chan, Suite 128, 108 N. Ynez Avenue, Monterey Park, CA, 91754, US

(21) Appl. No.: 10/290,878

(22) Filed: Nov. 12, 2002

(51) Int. Cl. H04J 3/02

(52) U.S. Cl. 370/537

(57) ABSTRACT

A DVD player system includes a DVD loader powered by the power input and arranged for reading storing data stored in a DVD and converting the storing data into digital data, a video/audio circuit control a data decoder converting the digital data into a video data and an audio data, a computer circuit control a device for converting the digital data into a computer readable data, and a function switch selectively switching the digital data directly from the DVD loader to the video/audio circuit control and the computer circuit control so as to connect the video/audio circuit control and the computer circuit control with the video/audio system as a DVD player and the computer system as a DVD drive respectively.

### BACKGROUND OF THE PRESENT INVENTION

1. Field of Invention

The present invention relates to a DVD player system, and more particularly to a portable DVD player system which is capable of utilizing not only as a regular DVD player for home entertainment but also as an external DVD drive for computer usage.

2. Description of Related Arts

Nowadays technology, compact discs, especially DVD, are not only widely used in the entertainment field but also used as data storage media for the computer. DVD has been well recognized as one of the convenient and inexpensive storage tools since it is light and handy and provided a large data storage capacity. People would like to play the DVD via a DVD player for watching movie since the DVD can provide better video quality and audio system, such as “dts” or “5.1 channels”. When the DVD player incorporates with another audio components, such as amplifier and satellite speakers, the user is able to built a fully equipped home theater system so as to enjoy the entertainment at home.

Furthermore, almost every common household owns a computer, DVD drive becomes a standard computer hardware to read data stored in the DVD. The difference between the DVD player and the DVD drive is that the DVD player is connected to a television by means of video and audio cables while the DVD drive is connected to the computer system by means of computer cable. It is because the DVD player firstly decodes the readable data in the DVD and converts the readable data into the video and audio data so as to transfer the video and audio data to the television through the video and audio cables respectively. However, the DVD drive can only send out the digital data as a computer readable format so that a data-decoding device must be installed into the computer system in order to read the readable data.

Since the home theater system and the computer system incorporate with different electronic configurations, the DVD player and the DVD drive are not interchangeable to utilize in different machines. In other words, when the user wants to watch the DVD with the home theater system, the DVD player must be used. Likewise, the user must use the DVD drive to read the DVD from the computer system. Therefore, the user must individually purchase the DVD player and the DVD drive for the home theater system and the computer system respectively.

Alternatively, in order to connect the DVD player to the computer system, a video-enhancing device, having video and audio inputs, can be installed into the computer system such that the DVD player is allowed to connect to the DVD player via the video and audio cables. However, the video enhancing device is too costly that is much expensive than the DVD player. In addition, when the DVD player is hooked up with the computer system, the DVD player functions as a movie playing device that the regular DVD drive has the same function as well.

### SUMMARY OF THE PRESENT INVENTION

A main object of the present invention is to provide a portable DVD player system for video/audio and computer systems which is capable of utilizing not only as a regular DVD player for home entertainment but also as an external DVD drive for computer usage.

Another object of the present invention is to provide a portable DVD player system for video/audio and computer systems, wherein the portable DVD player system comprises a function switch to selectively convert the readable data in the DVD into the video/audio format and the computer readable format for respectively transferring the video/audio system by means of conventional video and audio cables and the computer system via the conventional computer cable.

Another object of the present invention is to provide a portable DVD player system, which is capable of connecting to a conventional video/audio system to form a fully equipped home theater system so as to enhance the home entertainment for the user.

Another object of the present invention is to provide a portable DVD player system, which is designed to have a compact size that the user is able to carry the portable DVD player system everywhere to selectively connect with the video/audio system as the DVD player and the computer system as the DVD drive.

Accordingly, in order to accomplish the above objects, the present invention provides a portable DVD player system for video/audio and computer systems, comprising:

a power input electrically connected to a power source;

a DVD loader powered by the power input and arranged for reading storing data stored in a DVD and converting the storing data into digital data;

a video/audio circuit control comprising a main control unit, a data decoder controlled by the main control unit to convert the digital data into a video data and an audio data, means for outputting the video data to the video/audio system, and means for outputting the audio data to the video/audio system;

a computer circuit control comprising means for converting the digital data into a computer readable data and means for communicatively connecting the computer circuit control with the computer system so as to transfer the computer readable date to the computer system; and

a control unit comprising means for selectively switching the digital data directly to the video/audio circuit control and the computer circuit control so as to connect the video/audio circuit control and the computer circuit control with the video/audio system and the computer system respectively.

### BRIEF DESCRIPTION OF THE DRAWINGS

FIG. 1 is a perspective view of a portable DVD player system for video/audio and computer systems according to a preferred embodiment of the present invention.

FIG. 2 is a block diagram of the portable DVD player system for video/audio and computer systems according to the above preferred embodiment of the present invention.

### DETAILED DESCRIPTION OF THE PREFERRED EMBODIMENT

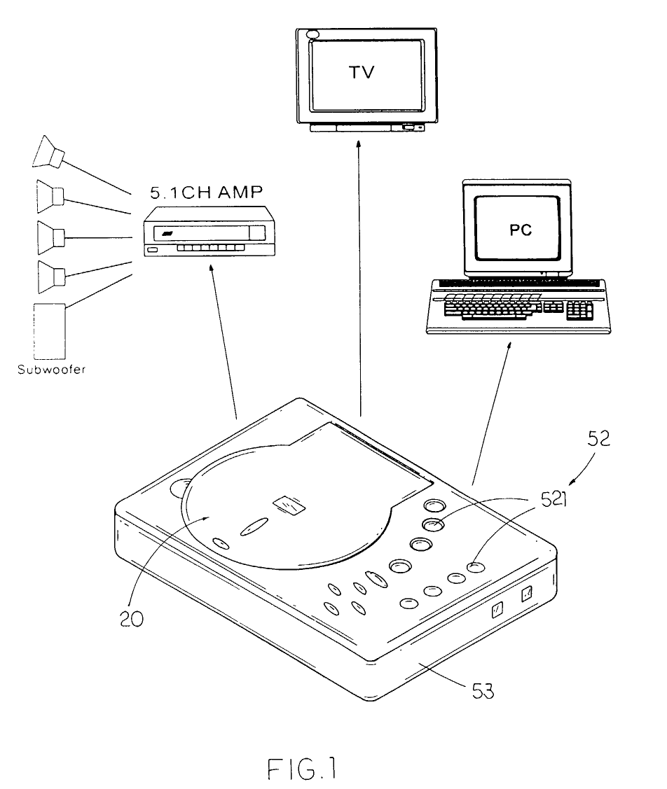

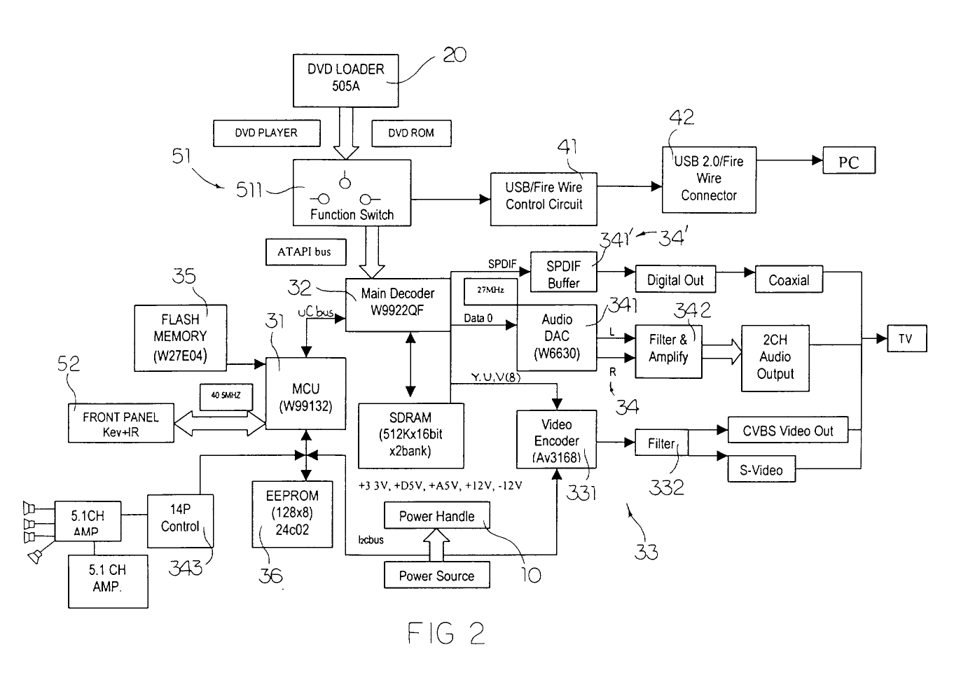

Referring to FIGS. 1 and 2 of the drawings, a portable DVD player system for video/audio and computer systems according to a preferred embodiment of the present invention is illustrated, wherein the portable DVD player system comprises a power input electrically connected to a power source, a DVD loader 20 powered by the power input 10 and arranged for reading storing data stored in a DVD and converting the storing data into digital data, a video/audio circuit control 30, a computer circuit control 40, and a control unit 50.

According to the preferred embodiment, the DVD loader 20 comprises a reading lens arranged to read the storing data in the DVD and an ATAPI interface to convert the storing data into the digital data. Accordingly, the digital data contains all the necessary information of the storing data in the DVD for both the video/audio and computer systems. The DVD loader 20 is preferred to read and convert the audio format, such as wav and mp3, and the video format, such as video compact disc VCD, into the digital data, so as to broaden the use of the portable DVD player system.

The video/audio circuit control 30 comprises a main control unit 31, a data decoder 32 controlled by the main control unit 31 to convert the digital data into a video data and an audio data, and means 33 for outputting the video data to the video/audio system, and means 34 for outputting the audio data to the video/audio system.

The computer circuit control 40 comprises means 41 for converting the digital data into a computer readable data and means 42 for communicatively connecting the computer circuit control 40 with the computer system so as to transfer the computer readable date to the computer system.

The control unit 50 comprises selectively switching the digital data directly from the DVD loader 20 to the video/audio circuit control 30 and the computer circuit control 40 so as to connect the video/audio circuit control 30 and the computer circuit control 40 with the video/audio system and the computer system respectively.

The switching means 51 comprises a function switch 511 which is electrically connected the DVD loader 20 with the video/audio circuit control 30 and the computer circuit control 40, is adapted to be switched between a video/audio mode and a computer mode. In which, when the function switch 511 is switched in the video/audio mode, the digital data is sent to the data decoder 32 of the video/audio control circuit 30, so that the portable DVD player system functions as a DVD player for the video/audio system, and when the function switch 511 is switched in the computer mode, the digital data is sent to the computer control circuit 40, so that the portable DVD player system functions as a DVD drive for the computer system.

As shown in FIG. 2, the video/audio circuit control 30 further comprises a memory means 35 for storing a command program as a driver for the main control unit 31 to control the data decoder 32, and a storage device 36 controlled by the main control unit 31 for storing a setting of the video/audio circuit control 30, wherein the main control unit 31 is driven by the memory means 35 and is capable of receiving a command order to select the setting in the storage device 36 for the video/audio circuit control 30.

The memory means 35 comprises a flash memory having a capacity adapted to store the command program for the main control unit 31. In addition, the storage device 36 is an EEPOM to store the setting of the video/audio circuit control 30, such as video and audio output formats, rating, and the television system information.

The data decoder 32 is a programmed system arranged for decoding the digital data into a video data and an audio data, wherein the video data and the audio data are stored in a SDRAM for further usage. It is worth mentioning that the video data and the audio data are in form of digital format after converted by the data decoder 32, the video data and the audio data must be further transformed before transferring to the video/audio system.

As shown in FIG. 2, the video output means 33 comprises a video encoder 331 electrically connected to the data decoder 32 to encode the video data into a video signal through a filtering circuit 332 wherein the video signal is capable of transferring to the video/audio system through a video cable (CVBS video out) or S-video cable.

The audio output means 34 comprises an audio DAC 341 electrically connected to the data decoder 32 to convert the audio data into an audio signal through a filter and amplify circuit 342, wherein the audio signal is capable of transferring to the video/audio system through an audio cable.

Alternatively, the audio output means 34 further comprises a buffer circuit 341′, such as SPDIF buffer, electrically connected to the data decoder 32 for transferring the audio data to the video/audio system through a coaxial cable.

The audio output means 34 further comprises means 343 for connecting the main control unit 31 with an amplifier device for audio enhancement. Accordingly, the amplifying connecting means 343 comprises a 14P control connector adapted for electrically connecting to the amplifier device so as to allow the user to set up a home theater system.

According to the preferred embodiment, the computer converting means 41 comprises a computer data circuit arranged for converting the digital data into a computer readable data. The computer connecting means 42 comprises a computer connector, such as a “USB” connector or a “FireWire” connector, electrically connected to the computer converting means 41 for connecting with the computer system through a computer cable in such a manner that the computer readable data is capable of transferring to the computer system through the computer cable. Preferably, the computer cable can be a “USB 2.0” cable or a “Firewire” cable that is able to transfer the computer readable data to the computer system in a high-speed manner.

When the portable DVD player system is connected to the computer system, the operation system of the computer system should automatically detect and recognize the portable DVD player system as the DVD drive, so that the user is able to control the portable DVD player system through the computer system. Therefore, the user is able to install any desired software into the computer system in order to read the computer readable data from the portable DVD player system of the present invention.

Accordingly, the function switch 511 is an auto switching device arranged in such a manner that when the portable DVD player system is connected to the video/audio system, the function switch 511 is automatically switched to the video/audio mode, and when the portable DVD player system is connected to the computer system, the function switch 511 is automatically switched to the computer mode. Alternatively, the function switch 511 can be a manual switch adapted to be manually switched between the video/audio mode and the computer mode by the user.

It is worth mentioning that the user must switch the function switch 511 in order to properly convert the digital data read from the DVD loader 20 into the video and audio data for the video/audio system and the computer readable data for the computer system. Therefore, the user is able to carry the portable DVD player system to hook up with the home theater system as the DVD player to enhance the home entertainment and to connect with the computer system as the external DVD drive.

The control unit 50 further comprises a control panel 52 having a plurality of function buttons 521 provided on a compact casing 53 to send the command order to the main control unit 31, so as to control the video/audio circuit control 30. In addition, the control unit 50 further comprises a remote control for controlling the video/audio circuit control 30. It is worth mentioning that when the portable DVD player system is connected to the video/audio system as the DVD player, the portable DVD player system provides a full play option as the conventional DVD player, such as slow motion, repeat, zoom function playback, parental control, etc.

What is claimed is:

1. A portable DVD player system for video/audio and computer systems, comprising:
a power input;
a DVD loader powered by said power input and arranged for reading storing data stored in a DVD and converting said storing data into digital data;
a video/audio circuit control comprising a main control unit, a data decoder controlled by said main control unit to convert said digital data into a video data and an audio data, means for outputting said video data to said video/audio system, and means for outputting said audio data to said video/audio system;
a computer circuit control comprising means for converting said digital data into a computer readable data and means for communicatively connecting said computer circuit control with said computer system so as to transfer said computer readable date to said computer system; and
a control unit comprising means for selectively switching said digital data directly from said DVD loader to said video/audio circuit control and said computer circuit control so as to connect said video/audio circuit control and said computer circuit control with said video/audio system and said computer system respectively.

2. The portable DVD player system, as recited in claim 1, wherein said switching means comprises a function switch which is electrically connected said DVD loader with said video/audio circuit control and said computer circuit control and adapted to be switched between a video/audio mode and a computer mode, wherein when said function switch is switched in said video/audio mode, said digital data is sent to said data decoder of said video/audio control circuit, so that said portable DVD player system functions as a DVD player for said video/audio system, and when said function switch is switched in said computer mode, said digital data is sent to said computer control circuit, so that said portable DVD player system functions as a DVD drive for said computer system.

3. The portable DVD player system, as recited in claim 1, wherein said computer connecting means comprises a USB computer connector electrically connected to said computer converting means for connecting with said computer system through a USB computer cable in such a manner that said computer readable data is capable of transferring to said computer system through said USB computer cable.

4. The portable DVD player system, as recited in claim 2, wherein said computer connecting means comprises a USB computer connector electrically connected to said computer converting means for connecting with said computer system through a USB computer cable in such a manner that said computer readable data is capable of transferring to said computer system through said USB computer cable.

5. The portable DVD player system, as recited in claim 1, wherein said computer connecting means comprises a “FireWire” computer connector electrically connected to said computer converting means for connecting with said computer system through a “FireWire” computer cable in such a manner that said computer readable data is capable of transferring to said computer system through said “FireWire” computer cable.

6. The portable DVD player system, as recited in claim 2, wherein said computer connecting means comprises a “FireWire” computer connector electrically connected to said computer converting means for connecting with said computer system through a “FireWire” computer cable in such a manner that said computer readable data is capable of transferring to said computer system through said “FireWire” computer cable.

7. The portable DVD player system, as recited in claim 2, wherein said video output means comprises a video encoder electrically connected to said data decoder to encode said video data into a video signal through a filtering circuit wherein said video signal is capable of transferring to said video/audio system through a video cable.

8. The portable DVD player system, as recited in claim 4, wherein said video output means comprises a video encoder electrically connected to said data decoder to encode said video data into a video signal through a filtering circuit wherein said video signal is capable of transferring to said video/audio system through a video cable.

9. The portable DVD player system, as recited in claim 6, wherein said video output means comprises a video encoder electrically connected to said data decoder to encode said video data into a video signal through a filtering circuit wherein said video signal is capable of transferring to said video/audio system through a video cable.

10. The portable DVD player system, as recited in claim 2, wherein said audio output means comprises an audio DAC electrically connected to said data decoder to convert said audio data into an audio signal through a filter and amplify circuit, wherein said audio signal is capable of transferring to said video/audio system through an audio cable.

11. The portable DVD player system, as recited in claim 8, wherein said audio output means comprises an audio DAC electrically connected to said data decoder to convert said audio data into an audio signal through a filter and amplify circuit, wherein said audio signal is capable of transferring to said video/audio system through an audio cable.

12. The portable DVD player system, as recited in claim 9, wherein said audio output means comprises an audio DAC electrically connected to said data decoder to convert said audio data into an audio signal through a filter and amplify circuit, wherein said audio signal is capable of transferring to said video/audio system through an audio cable.

13. The portable DVD player system, as recited in claim 10, wherein said audio output means further comprises a buffer circuit electrically connected to said data decoder for transferring said audio data to said video/audio system through a coaxial cable.

14. The portable DVD player system, as recited in claim 11, wherein said audio output means further comprises a buffer circuit electrically connected to said data decoder for transferring said audio data to said video/audio system through a coaxial cable.

15. The portable DVD player system, as recited in claim 12, wherein said audio output means further comprises a buffer circuit electrically connected to said data decoder for transferring said audio data to said video/audio system through a coaxial cable.

16. The portable DVD player system, as recited in claim 12, wherein said audio output means further comprises means for connecting said main control unit with an amplifier device.

17. The portable DVD player system, as recited in claim 15, wherein said audio output means further comprises means for connecting said main control unit with an amplifier device.

18. The portable DVD player system, as recited in claim 2, wherein said video/audio control further comprises a memory means for storing a command program for said main control unit to control said data decoder, and a storage device controlled by said main control unit for storing a setting of video/audio circuit control, wherein said main control unit is driven by the memory means and is capable of receiving a command order to select said setting in said storage device for said video/audio circuit control.

19. The portable DVD player system, as recited in claim 16, wherein said video/audio control further comprises a memory means for storing a command program for said main control unit to control said data decoder, and a storage device controlled by said main control unit for storing a setting of video/audio circuit control, wherein said main control unit is driven by the memory means and is capable of receiving a command order to select said setting in said storage device for said video/audio circuit control.

20. The portable DVD player system, as recited in claim 17, wherein said video/audio control further comprises a memory means for storing a command program for said main control unit to control said data decoder, and a storage device controlled by said main control unit for storing a setting of video/audio circuit control, wherein said main control unit is driven by the memory means and is capable of receiving a command order to select said setting in said storage device for said video/audio circuit control.
